(19) United States
(12) Patent Application Publication
(10) Pub. No.: US 2006/0249401 A1
(43) Pub. Date: Nov. 9, 2006

(54) apparatus and method for determining a chemical element

(76) Inventors: Mirko Lehmann, Freiburg (DE); Maximilian Fleischer, Hoehenkirchen-Siegertsbrunn (DE)

Correspondence Address: Patrick O'Shea;O'Shea, Getz & Kosakowski, P.C., 1500 Main Street, Suite 912, Springfield, MA, 01115, US

(21) Appl. No.: 10/867,177

(22) Filed: Jun. 14, 2004

(30) Foreign Application Priority Data
Jun. 12, 2003 (DE) 103 26 476.0-52

(51) Int. Cl. G01N 27/26

(52) U.S. Cl. 205/775; 204/431

(57) ABSTRACT

Sensor for determining a chemical element and method for controlling such a sensor. The invention relates to a sensor (1) for determining a chemical element or a chemical compound (CO₂) in a supplied gaseous medium with
a reaction area (9), on and/or in which the element or the compound brings about a chemical reaction that changes a characteristic parameter (for example the work function), Version 3* of the reaction area (9),
a sensor element (5) that is placed in the sensor (1) to detect the change in the characteristic parameter,
a signal output (11) at which an output signal (U_{PS}) corresponding to the chemical reaction detected by the sensor element can be detected as the measured variable, and
a reaction control device (SC, 12) with an electrode system (10, 13) for applying a control voltage to affect a reaction in the reaction area (9).

To be able to use the sensor more variably and more reliably, it is proposed to produce a surface topology of such dimensions that during operation, a moisture film (16) of deposited ambient moisture continuously coats the surface area of both the electrode system and the reaction area. Possibilities in particular are correction of long-term changes from the influence of surrounding gases, checking probe functionality, and selective adjustment to measure given chemical variables.

This invention relates to a sensor for determining a chemical element or a chemical mpound in a gaseous medium with the features of the preamble of claim 7, and to a method for controlling such a sensor.

Sensors that have a sensor layer on and/or in which an element or a compound produces a chemical or physical reaction for determining the chemical element or the chemical compound in a gas or fluid are generally known. Their output signal is usually an electrical signal that is produced by a reversible gas-induced change in a characteristic parameter of the sensitive material of the sensor layer.

DE 100 28 692 C2 discloses a method for examining biocompartments enclosed by membranes. Liquid containing such a biocompartment is managed by a sensor device. The sensor device has multiple ion-selective field effect transistors at the bottom of a measurement chamber. These have a substrate consisting of a semiconductor material in which there are highly doped zones with a functional type opposite to the substrate, for the drain and source. There is a gate between drain and source. The gate, drain, and source are electrically insulated from the measurement chamber by a silicon nitrite layer above them. The silicon nitrite layer constitutes an active sensor layer on their exterior away from the gate, by which the field effect transistor can be controlled by means of hydrogen ions located there in a culture medium. An output signal is generated by the field effect transistor, and is about proportional to the pH of the culture medium.

Adjacent to the gate there is a working electrode as a control electrode (guard ring), which surrounds the gate annularly. Associated with the working electrode is a reference electrode that is spaced apart from the field effect transistors in the liquid tap. The working electrode and reference electrode constitute an electrode system for applying a control voltage to the liquid that flows through the measurement chamber. One of the purposes of this system is indirect measurement of the respiratory activity of the biocompartments from the application of various operating voltages to this electrode system, and measurement of corresponding changes in the measured pH, using the field effect transistor.

Sensors in which a change in the work function of the sensitive material is brought about by the chemical or physical reaction are generally known.

Because of the adjacency of the sensitive material, typically with a spacing of less than 5 μm, or an electrical coupling to the gate of a field effect transistor structure, the change in work function affects the source-drain current of the field effect transistor as long as the current is not held constant by other electrical measures (suspended gate FETs=SGFETs). Such sensors, when they are used in liquids, are also called ion-sensitive field effect transistors (ISFET). In principle, an ISFET is constructed similarly to a field effect transistor with a metal electrode for control, but with the control in the case of the ISFET not occurring by means of the metal electrode but through a system consisting of an ion-sensitive layer, electrolyte, and reference electrode. Such ISFETs are ordinarily used as pH sensors but can also be used as transducers for SGFETs (see DE 19956744C2). In the same way, with an SGFET system, the signal can be transmitted capacitively from an electrode to a transistor, in which case the transistor does not have to be positioned opposite the sensitive material (capacitive controlled FET; CCFET) (see DE4333875C2).

Two different gas sensor systems are generally known. In the first sensor system the sensor reaction occurs on the sensor layer, which is separated by an air gap from the transducer (ISFET, CCFET). In the second sensor system, the sensor reaction occurs on the sensor layer, which is directly on the ISFET or CCFET.

While the sensitive material of the sensor layer ordinarily has long-term resistance to ambient air, nevertheless the pH of a natural moisture film on the surface often changes during long-term operation from the action of ambient gases. With the change in the pH of the film of moisture on the surface, the gas-sensitive reactions it mediates and with them the sensor behavior also change, so that distortion of the measured parameter occurs over a lengthy measurement procedure.

The goal of this invention consists of making available a method and a sensor for determining a chemical element or a chemical compound in a gas or fluid supplied in that regard.

This goal is achieved by a sensor for determining a chemical element or a chemical compound in a supplied gas or fluid with the features of claim 7 and by a method for determining a chemical element or a chemical compound with the features of claim 1.

Particularly advantageous is a method for determining a chemical element or a chemical compound in a gaseous medium that is supplied to a sensor for detecting a change in a reaction area when the chemical composition in the reaction area of the sensor is actively changed by applying or changing a control voltage in a moisture film over and/or in the reaction area.

The design of a sensor for determining a chemical element or a chemical compound in a supplied gaseous medium is especially advantageous when the sensor is equipped with: a reaction area on and/or in which the element or the compound brings about a chemical reaction that changes a characteristic parameter of the reaction area; a sensor element that is located in the sensor for detecting the change in the characteristic parameter; a signal output from which an output signal corresponding to the chemical reaction detected by the sensor element can be tapped; and a reaction control device with an electrode system for applying a control voltage to influence a reaction in the reaction area, a surface topology and surface chemistry being of such dimensions and/or design that during operation a continuous moisture film of deposited moisture coats the surface area of both the electrode system and the reaction area. It must be noted that generally there are thinner moisture films on hydrophobic surfaces than on hydrophilic surfaces, so that a hydrophilic surface is preferred for contact between the reaction area and the electrode systems. The surface topology/chemistry, with appropriate dimensions, makes possible a continuous moisture film, without which inadequate conductivity would exist, for example if the steps between individual topology elevations are too large, so that control of the chemical properties in the sensitive area would not be possible.

In the sensor and the method for determining a chemical element, use is made of the knowledge that when there is contact of a gas mixture containing moisture with the surface of the sensor layer, a moisture film is formed on the surface at temperatures from room temperature to typically 100° C. that is sufficient for a chemical reaction therein.

The moisture film that is deposited on the surface is usually in the nm range. “Gaseous medium” signifies in particular a gas mixture containing moisture, i.e. a moist gas or fluid.

In the simplest case, it is sufficient for the moisture film to extend continuously over the surface area between at least two electrodes and the reaction area.

Besides stabilization of the sensor layer in long-term operation and to correct pH deviations of the moisture film, active shifts in the characteristic parameter from the influence of ambient gases are also possible. This makes it possible on the one hand to check the general functionality of the sensor, and on the other hand to use the sensor to determine different chemical elements or compounds. Appropriate methods of managing such a sensor layer control device provide appropriate corrections in long-term operation, checks, or the possibility of using different chemical elements or compounds.

Advantageous embodiments are the object of dependent claims.

The design of the control device as a stabilizing device or a corresponding procedural method leads to a change in the chemical composition of the sensor layer by electrochemical mechanisms, so that the characteristic parameter can be kept at a constant level even during long-term operation, for example in order to neutralize the effects of ambient gases. For example, holding the pH in the moisture film constant guarantees that the output signal is always in a direct ratio to the amount of the chemical element or chemical compound in the gas or fluid that is supplied to the sensor layer.

The design of the sensor layer control device as a test device and an appropriate procedural method utilizes a deliberate change in the characteristic parameter, especially of the pH, with otherwise constant conditions, to obtain one, two, or preferably multiple measurements, so that the corresponding output signals can be examined for any possible defective functioning of the sensor layer. A test value or a corresponding sequence of test values determined in this way can beneficially be compared in a simple way with corresponding reference values that can be stored in a memory.

It is also advantageous to design the sensor layer control device as a sensitivity setting device and a corresponding procedural method, with the characteristic parameter, particularly the pH, being actively adjusted electrochemically to a value that establishes the desired sensitivity of the sensor layer to a given chemical element or a given chemical compound. This makes it possible to use the sensor for determining various chemical elements or compounds. It is also advantageous for the sensitivity setting to have suitable reference values available in a memory.

Exemplary embodiments of the invention will be described in further detail below with reference to the drawings:

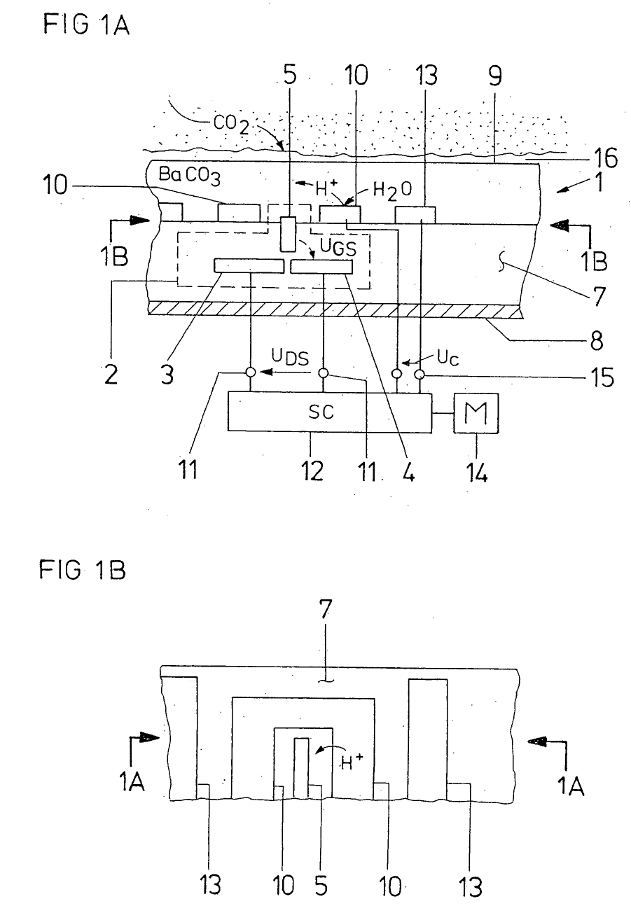

FIGS. 1A, 1B show, schematically for clarity, necessary components of a sensor for determining a chemical element in a gas;

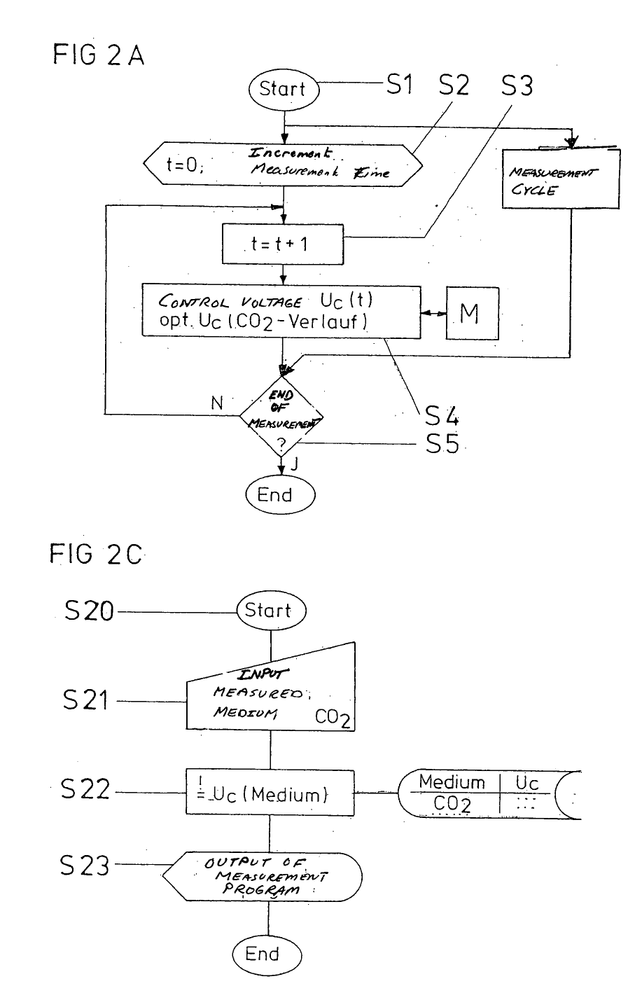

FIG. 2A is a flow diagram to illustrate a stabilizing control for such a sensor;

FIG. 2B is a flow diagram to illustrate a method for testing the functionality of such a sensor;

FIG. 2C is a flow diagram to illustrate the procedural method for setting the sensitivity of such a sensor;

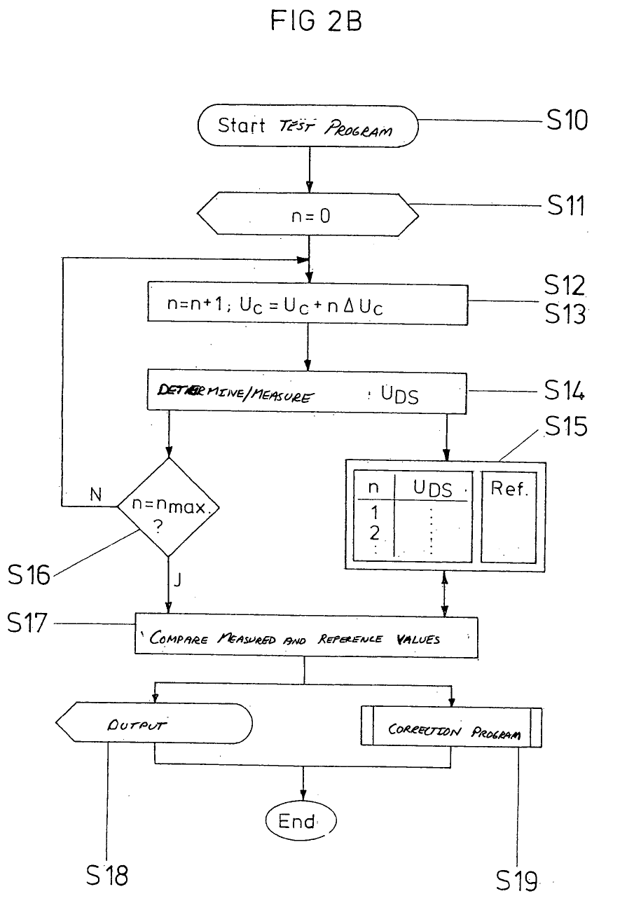

FIG. 3 is a diagram with curves to illustrate a reduction of aging effects of a sensor layer;

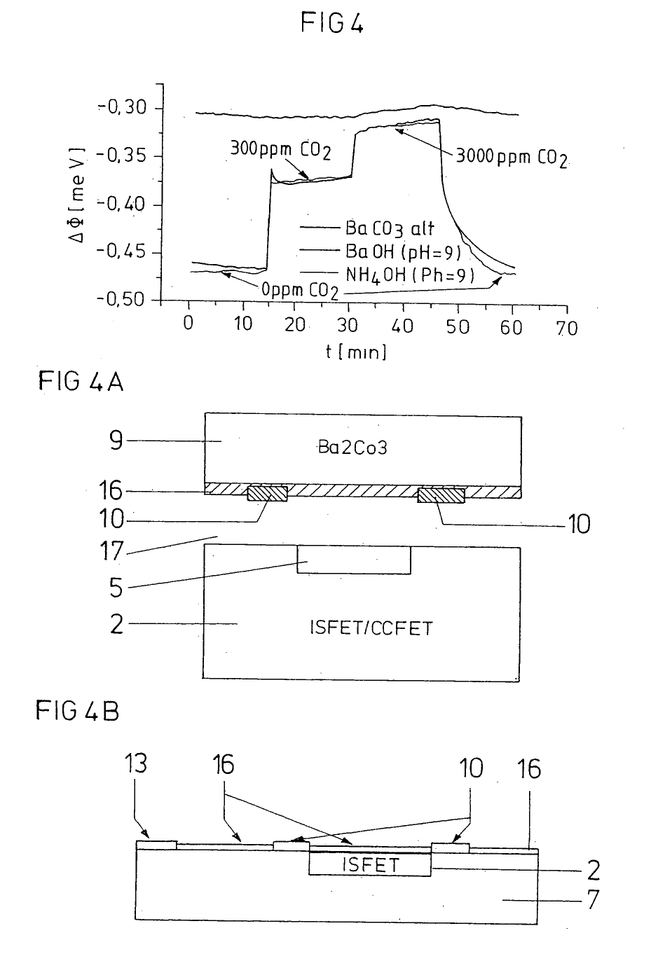

FIGS. 4A, 4B show schematically two especially simple embodiments in cross section;

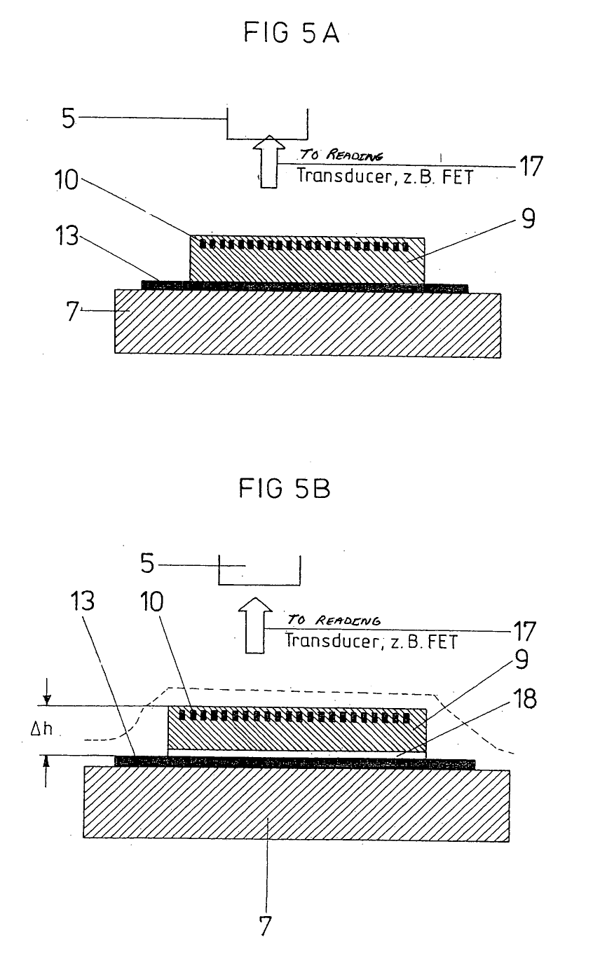

FIGS. 5A, 5B show two alternative embodiments for arranging the control electrodes;

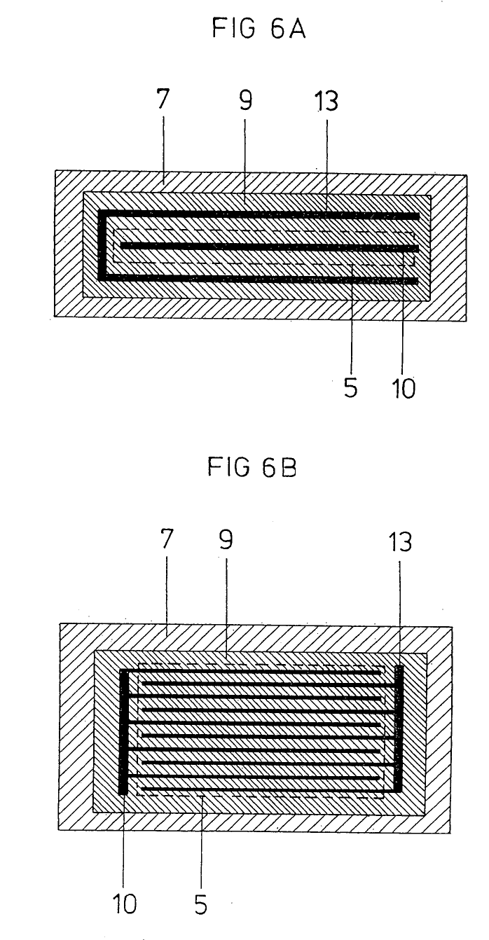

FIGS. 6A, 6B show, in top view, two examples of electrode arrangements.

As may be seen in FIGS. 1A and 1B, a sensor for determining a chemical element or a chemical compound in a supplied gas or fluid consists of a plurality of components, known in themselves, of which only the elements necessary for a basic understanding are depicted. In particular, it is possible to carry over the system and procedural method described below to other sensors. When a chemical element is described below as a parameter to be determined, it must be understood to include chemical compounds. When a gas is described, fluids or moist gasses that are supplied to the sensor layer are also included. As a characteristic parameter described below that affects the output signal as the measured variable of an electrochemical reaction, only the pH is given as an example of various types of characteristic parameters.

A sensor 1 is shown by way of example, with an ion-selective field effect transistor (ISFET) 2. The ion-selective field effect transistor 2 consists in the usual way of a drain 3, a source 4, and a gate 5, with customary wiring. These are embedded in an insulator or semiconductor material 7 that is produced on a carrier or substrate 8. The gate 5 in the present embodiment extends out from the surface of the insulator or semiconductor material and into a sensor layer 9 placed thereon, made of sensitive material. The electrode constituting the gate 5 is usually designed to extend lengthwise through the transition region of these layers. However, the gate can also be located buried in the semiconductor material 7. In a known manner, the gate 5 is enclosed in a protective or guard ring 10 with a width, for example, of 8 μm.

With the usual arrangement of the sensor 1, a supplied gas, fluid, or other appropriate medium with CO₂, for example, as the gas to be determined, reaches the open surface of the porous sensor layer 9 with a suitable chosen sensitive material and there leads to a chemical reaction. This chemical reaction in turn causes a change in the work function in the sensitive material in the vicinity of the gate 5, which in turn leads to a changed voltage U_{GS} between gate 5 and source 4 as well as a changed voltage U_{DS} between source 4 and drain 3. The voltage U_{DS} between source 4 and drain 3 or a corresponding current serve as the detectable output signal U_{DS} at a corresponding signal output 11 of the sensor 1.

With the sensor 1, the sensor layer 9 thus constitutes a reaction area on and/or in which the element or the compound produces a chemical reaction that modifies a characteristic parameter of the reaction area. The ISFET, in particular its gate 5, serves as the sensor element that is located in the sensor to detect the change in the characteristic parameter pH. In the electrode system of a reaction control device to apply a control voltage to affect a reaction in the reaction area, the protective or guard ring 10 serves as a first electrode, and a reference or control electrode 13 separated therefrom serves as a second electrode.

When one or both of the electrodes 10, 13 is/are placed within the sensitive material for applying a control voltage U_{C}, the sensitive material of the sensor layer 9 is suitably made porous and capillary so that water molecules are found on the surfaces within the porous material. Moisture film 16 in a porous layer designates not only the moisture film on the outer surface but also the moisture film on the internal surfaces. To be able selectively to affect the functionality of the sensor 1, the variable voltage U_{C} is applied to the guard ring 10 by using a sensor layer control device 12/SC. To this end, it is desirable for the control electrode 13 to be placed next to the guard ring 10 so that they constitute an electrode system for applying the control voltage U_{C}. In the embodiment shown, the control electrode 13 is likewise in the sensor layer 9.

For this purpose, the water H₂O that is always present in any case is used as the moisture film 16 on and in the sensor layer 9 in the region of the guard ring 10. By applying an appropriate control voltage U_{C}, bringing about a relative positive or negative flow of current, the water in the sensor layer is oxidized or reduced, and positive hydrogen ions H⁺ or negative OH⁻ ions are formed. These generated ions bring about a decline or rise of the pH in the sensor layer 9.

For implementing the various advantageously usable procedural methods, the sensor layer control device 12 is coupled to a memory 14/M in which reference values and measured values are stored, along with algorithms. It is also possible to provide for a control input 15 to connect the guard ring 10 and the control electrode 13 to an external control device.

The sensor described here, without limitation to such a model, relates to a type of sensor by way of example for use at temperatures preferably, but not exclusively, from room temperature to typically 100° C., with the sensor 1 being operated in a gas mixture or fluid containing moisture. During operation, there is a moisture film 16 on the surface of the sensor layer 9.

When BaCO₃ is used as the sensitive material of the sensor layer 9, the sensor is one for CO₂ especially, for example, with supplied CO₂ causing a gas-induced change in the sensitive material. When CO₂ is supplied during moist gassing, and when CO₂ dissolves in the moisture film 16 on and in the surface of the sensor layer 9, bicarbonate is formed on BaCO₃ as follows:
(CO₂+H₂O+CO₃⁻→2HCO₃⁻).
The material parameter “work function” changing in this case as the characteristic parameter, according to the Nernst equation
ΔΦ=kT/2e log[CO₂]+kT/2e log[H₂O]−kT/e log[HCO₃]
depends on the CO₂ concentration, with k representing the Bolzmann constant, T the temperature, and e the elemental charge.

During operation, in other words, supplying CO₂ to the sensor layer 9 for a lengthy period of time at room temperature, however, the sensitivity of the sensor layer 9 declines. This is because of acidification of the moisture film 16 on the surface of the sensor layer 9 during operation, whereby the solubility of CO₂ is drastically reduced. Ultimately, this causes changed voltages between gate 5 and source 4, and between source 4 and drain 3, and thus a changed or distorted output signal U_{DS}.

To compensate for the change or shift in the pH of the moisture film 16, so that the solubility of CO₂ in the moisture film 16 is again the same as at the beginning of measurement, appropriate guidance of the sensor layer control device 12 takes place. By applying a control voltage U_{C} to the control electrode 13 and to the guard ring 10, water molecules adjacent to the guard ring 10 or in it are cleaved, and positive hydrogen ions H⁺ or OH⁻ ions are liberated, which diffuse into the sensor layer 9. The formation of OH⁻ ions causes a shift in the pH of the moisture film 16 on and/or in the sensor layer 9, modified by the acidification, into the alkaline range. CO₂ can again be dissolved in the usual amount, so that the output signal U_{DS} detectable at the signal output 11 again represents the correct value of the CO₂ content of the supplied gas.

An appropriate control method for such stabilization of the sensor layer 9 using the sensor layer control device 12 as a stabilization device consists according to FIG. 2A, for example, of a sequence of a few process steps. After the start SI of the program execution, a time value t is set at zero in the next step S2, and is incremented as the time of measurement progresses (S3). With the progress of time t, the control voltage U_{C}(t) is raised or lowered as needed. It is advantageous to be able to call for appropriate values for the control voltage U_{C} from the memory M. After this step S4, a check is made in a following step S5 to see whether the measurement cycle has been completed, i.e. the end of measurement has been reached. If it has not, the procedure is continued with incrementation of time (S3) and readaptation of the control voltage U_{C}. If it has, the end of the control program has been reached.

The control program described can be used advantageously to stabilize the sensor layer 9 and the moisture film 16 in parallel, or can be carried out as a subprogram for a measurement program. As an alternative to changing the control voltage U_{C}(t), the control voltage U_{C} can also be adapted according to other criteria. For example, the CO₂ curve can be averaged, and can be used as a correction variable for the control voltage U_{C} in case of changes progressing uniformly over time.

This method can be used in particular for the series of sensitive materials for which the moisture film 16 on or in the sensor layer 9 is decisive for the existence of the gas-sensitive reaction. Such sensitive materials, besides the known metal oxides, are especially the salts from the group consisting of carbonates, phosphates, halides, and nitrates. It is thus possible by the procedural method to compensate for effects of ambient gases in case of long-term operation with a change in the pH of the moisture film 16, by compensating for the pH of the moisture film 16 from a gas-sensitive reaction by applying the control voltage U_{C} to the control electrode 13 and to the guard ring 10, or to another appropriate electrode instead of the guard ring 10.

In the described embodiment, electrochemical production or destruction of hydrogen ions H⁺ is carried out in order to affect the pH of the moisture film 16 on and in the sensor surface 9, in particular to hold it constant in order to produce a sensor signal as an output signal U_{DS} that is stable over the long term.

A method for checking the functionality of the sensor 1 and of the sensor layer 9 or of a moisture film 16 on it or in it according to the flow diagram of FIG. 2B also rests on the same basic principle. In this case, the starting material is the same class of gas-sensitive materials as described above, and an active temporary shift in the pH on or in the surface of the sensitive material can likewise be used. The gas-sensitive properties of the sensor material are thereby changed, and with them also the characteristic gas-sensitive parameter of this material. This change is then converted into the electrical output signal U_{DS}, which can be detected at the signal output 11. This output signal U_{DS} can also be fed directly to the sensor layer control device 12.

The sensor layer control device 12 with functionality as a test device changes the control voltage U_{C} between the guard ring 10 and the control electrode 13 continuously or stepwise. The corresponding change in the output signal U_{DS} is also determined. The sensor layer control device 12, or if necessary also an external control device, checks the functionality of the sensor 1 by evaluating the change in the output signal U_{DS}, in particular by equalization with reference values in the memory 14 and with a reference table stored there.

In case the value of the output signal U_{DS} differs from the prescribed standard or reference values, defective functioning of the sensor 1 is to be assumed. It is desirable to output a corresponding result that signals an interruption of the measurement process or an alarm function for possible differences.

It is possible in particular to start a correction program that corrects the determined error. Such a correction program can refer back to changing output signals U_{DS}, particularly with the sensor being checked repeatedly at prescribed time intervals by this method, and can make the corresponding corrections. For example, an algorithm according to FIG. 2A can be used to carry out the corrections to stabilize the sensor layer 9.

According to the flow diagram shown by way of example, the test run begins in a process step S10. This is followed by setting a numerical parameter n at zero (S11). The numerical parameter is then incremented (S12), whereupon a differential control voltage ΔU_{C} correspondingly multiplied by the correction value n is added or subtracted (S13). The value of the output signal U_{DS} at the signal output 11 changed by the changed pH conditions at or in the sensor layer 9 is then determined, suitably assigned in a table to the corresponding correction value n, and stored (S14, S15). A check is then made to see whether the correction value n has reached its maximum value nₘₐₓ (S16). If it has not, there is a jump back, and the increase of the correction value n is continued (S12). If it has, the measured value that is read from the memory M for the purpose is analyzed in a following step (S17). The result is then output (S18), especially when a difference has been found. After the output of the result, the algorithm is either terminated, or an appropriate correction program is started before the termination.

Besides the stabilization of the sensor layer or the checking of the sensor layer, a direct effect on sensitivity for other purposes is also possible, for example as shown by the process algorithm in FIG. 2C. Materials like the above starting materials, from the same class of gas-sensitive materials, are again preferably used, and an active shift in the pH of the moisture film 16 on or in the surface of the sensitive material 9 is also used. The pH again affects the sensor reaction, and with a shift in the sensitivity of the sensor layer 9. This can be used to permit measurement of various chemical elements or chemical compounds using one and the same sensor 1.

For example, CO₂ can be partially dissolved in a neutral surface water film to give carbonic acid, by which a gas-sensitive reaction can be brought about on carbonates as an example of sensor material, making CO₂ detection possible. However, if the pH of this moisture film 16 on the surface of the sensor layer 9 is shifted into the acidic range, CO₂ no longer dissolves in the moisture film 16 of the sensor layer 9, since carbonic acid is only a weak acid and the sensitivity decreases with respect to carbonic acid. However, in this state of the sensor layer 9, NO₂ for example that is supplied to the sensor layer can still be detected since NO₂ is the anhydride of a strong acid.

The corresponding example of a flow diagram, after the start (S20), consists of the manual or automatic input (S21) of the chemical element or of the chemical compound to be measured, i.e. of the measurement medium. Next (S22), an appropriate control voltage U_{C} is established that is necessary for shifting the pH as the measured parameter, for example, for determining the desired chemical element. For this purpose, a corresponding table with correlation of the measurement medium and control voltage, which is stored in the memory 14 for example may be used. After determining the control voltage U_{C}, this is output to the measurement program (S23), which then performs the corresponding control using the sensor layer control device 12 as a sensitivity-adjusting device. The algorithm is then terminated.

FIG. 3 shows a comparison of synthetic curves that outlines a correction of an aging effect of a sensor 1, which can be compensated for, for example, using the stabilization program according to FIG. 2A. In comparison with the reactions of an aged specimen based on BaCO₃, the sensor layer regenerates after a gas swing from 300 ppm CO₂ to 3,000 ppm CO₂ and back to 0 ppm CO₂, after appropriate guidance, somewhat like a new probe. Thus, what is graphically shown is an example of the mode of operation of the procedure of CO₂ measurement with BaCO₃ as the sensor layer by reading the work function. The curve of the new layer shows good response to the concentrations to be detected; an old layer shows poor response or response that can no longer be utilized, with almost constant work function potential. The original sensitive behavior can be restored by regeneration through proton withdrawal, i.e. by adding OH⁻, as shown by the third dashed-line curve.

Of course, the essential components of such a sensor 1 that by themselves are sufficient for the reaction of the method are a carrier with such a sensor layer 9, an electrode serving as gate 5, and an electrode system corresponding to the guard ring 10 and the control electrode 13, with appropriate connections 15 as control input 15 for applying the control signal U_{C}.

Especially simple embodiments of a sensor 1′ are shown with reference to FIGS. 4A and 4B. In these and the other figures, for simplification, for the most part only the sensor elements and sensor functions that differ from those otherwise described are described here. In particular, the same reference symbols stand for elements with the same action or of the same type.

FIG. 4A shows an embodiment in which the sensitive sensor layer 9 that constitutes the actual reaction area is placed apart from the sensor element (SGFET). The separation is across a gap 17 that serves as a passage for the flow of gaseous medium, Again, the guard ring 10 and a reference electrode as control electrode are located on the sensitive layer 9. In the exemplary embodiment shown, these electrodes 10, 13 are applied to the surface of the sensitive layer and stand out from it. The moisture film 16 is formed correspondingly in an area on the surface of the sensitive layer 9, with the moisture film 16 wetting both the reaction area of the surface and at least the lateral electrically conducting flanks of the gate ring 10. Modification of the pH in the moisture film 16 again occurs electrochemically when a control voltage is applied to the guard ring 10*.

The sensor described detects the potential change based on a change in work function.

A pH change takes place in the moisture film and/or in the sensor layer in this exemplary embodiment as well, because of the reduction or oxidation of water in the environment of the guard ring 10 and thus in the sensitive material, when a voltage is applied between the guard ring, which preferably consists of noble metal, for example platinum or palladium, and the reference electrode 13, which consists of silver or silver chloride, for example. In particular, the reaction of barium carbonate BaCO₃ with a gaseous medium containing carbon dioxide CO₂ is strongly pH-dependent. By applying the voltage, an electrochemical reaction takes place on the guard ring 10 that generates protons or OH⁻ ions according to the equation
O₂+2H₂O⁻+2e→H₂O₂+2OH⁻.

Because of this, acidification takes place in the reaction area on the sensor layer 9, i.e. over or opposite to the gate 5 of the ISFET.

It is advantageous for the reference and control electrode 13 to have a volume several orders of magnitude larger, so that the pH change on the control electrode 13 is not as severe as on the guard ring 10. However, it is also sufficient to use a simple counterelectrode as the control electrode. A microelectrode or nanoelectrode is preferably chosen as the size of the guard ring 10 or of one or more electrodes, in simple cases including point electrodes or linear electrodes, in order to be able to utilize the electrochemical properties of microelectrodes for this case. This entails a smaller current and thus a lesser current decrease.

For example, it is also possible to determine the oxygen content of liquids on a guard ring by applying an appropriate reduction voltage for oxygen, thus in particular about −700 mV according to Original German has “gate ring 10,” presumably in error. Translator. the above formula. Oxygen is thereby reduced to OH⁻, with the ISFET 2 detecting according to a simplified representation:
O₂+2H₂O⁻+2e→H₂O₂+2OH⁻

It is also possible to apply more-positive voltages, for example +700 mV, in order to oxidize more-electropositive substances. In this case protons H⁺ are formed, which in turn can be detected with the ISFET 2, for example according to the equation:
NO+H₂O→NO₂⁻+2H⁺+e⁻.

When even higher negative voltages are applied, water is reduced to OH⁻ and with even more-positive voltages water is oxidized to H⁺.

A particularly simple embodiment corresponding to FIG. 4B consists of a carrier 7 in which an ISFET 2 is embedded. There are one or more reference and control electrodes 13 and one or more guidance, protective, or guard ring electrodes 10 on the common, preferably flat surface of the carrier 7 and of the ISFET 2. In operation, i.e. when a gaseous medium with a moisture content is supplied, a moisture film 16 is formed on the surface of the carrier 7, which extends between the control electrode 13 and the guard ring 10, as well as into the reaction area 9 inside the guard ring 10. With such an arrangement, for example, information can be obtained about the oxygen content of the environment of this system with the assistance of Henry's law (the amount of a gas in a liquid is proportional to the gas pressure with which the liquid is in equilibrium). The carrier material and also the reaction area can also be made without barium carbonate BaCO₃, which is used as the sensor layer in the first described embodiment.

FIGS. 5A and 5B represent cross sections through systems with relatively thick sensitive layers 9. A first electrode 10 of the electrode system is embedded in the upper region of the sensor layer 9 or rests on it for applying the control voltage. The second electrode 13 of the electrode system is separated from this first electrode 10. The bottom of the sensor layer 9 thus rests on the second, preferably sheet-like electrode 13. It is advantageous for the second electrode 13 to rest on a carrier 7. A transducer, preferably a field effect transistor, is used to read out a change in the characteristic parameter, i.e. of the pH in the moisture film 16 that surrounds the sensor layer 9 in particular. It is separated from the sensor layer 9 by a gap 17 in such a way that it is opposite the electrode system 10,13.

With this system, a rear electrode 13 is thus used that may be of sheet-like design. The counterelectrode 10 is advantageously made up of a linked network of individual electrodes, for example in the form of a comb-like structure. The first electrode is located in this case in the area of the surface of the sensor layer 9, where the sensor signal that is read by the suitably positioned transducer is produced. In other words, the pH generated there affects the gas-sensitive part of the system and hence the sensitive behavior. An opposite pH change at the second electrode 13 separated by the gap 17 is not located in the signal-determining part of the sensitive sensor layer 9 and advantageously has no effect on the gas-sensitive behavior.

In long-term operation, an unwanted accumulation of acid or base may develop at the first electrode 10, which guides in the gaseous medium and faces the moisture-bearing surface of the sensor layer 9. This is the case, for example, when acidic coating occurs persistently from the surroundings, i.e. when at the same time a base accumulates at the second electrode to compensate. In this case, an increasingly acidic medium will develop at the first electrode. In order to eliminate such long-term effects, an appropriate chemical buffer can be placed in the surroundings of at least one of the electrodes 10, 13 that prevents such unwanted accumulation at the electrode adjacent to the buffer. FIG. 5B shows a buffer 18 between the sensor layer 9 and the second electrode 13, for example.

FIG. 6A shows another embodiment that carries out pH control only in the readout region of the layer. In this case, a reading transducer, for example with a gate 5 of an ISFET, is again placed in the substrate 7. The sensitive layer 9, which carries an electrode system consisting in the illustrated example of a linear first electrode 10 and a second electrode 13 wrapped around it in a U-shape, is located above the substrate 7 and the reading transducer. The active reaction area with this arrangement is located in the field surrounding the first electrode 10 and in the sensor layer 9 beneath and diagonally beneath the first electrode 10. With this system, only the layer region of the transducer detected by the first electrode is read. The layer region of the sensor layer 9 affected by the second electrode 13 in this case is separated laterally. A buffer can again be placed in particular with the second electrode 13 in this embodiment also.

The case in which the opposite pH shift occurs should also be emphasized. This case causes no interfering measurement effect at the outer electrode 13, but only suppresses the measurement effect. This also makes possible especially the use of interdigital forms of electrodes, with the layer region of the sensor layer 9 detected by the first electrode producing a sensor signal, but with that detected by the second electrode not contributing to the signal.

Particularly advantageous are systems in which the sensor is produced using a conventional semiconductor manufacturing process, with attention being paid to the smoothest possible shape with a view to the surface topology. Height differences in the region of the reaction area and of the electrode system adjacent to it for applying the control voltage should be finished to be so low that the moisture film 16 coats the individual areas continuously. A continuous coating means that the oxidation or reduction of water or of another suitable moisture film medium 16 can be accomplished by the applied potential. Surface topologies customary at the present time should therefore have height differences that permit a typical moisture film 16 with a thickness of a few nanometers. A surface topology that avoids sharp edges that can lead to detachment of the continuous moisture film 16 is especially beneficial. Steps of the surface topology or radii of rounded transitions of height in this case should not exceed a few nanometers to a few tens of nanometers. When particularly wet gases or high ambient moisture with correspondingly thick moisture films 16 on the sensor layer are used, these dimensions can be correspondingly larger, and can definitely also extend into at least the micrometer range.

1. Method for determining a chemical element or a chemical compound in a gaseous medium that is supplied to a sensor for detecting a change in a reaction area, comprising applying or changing a control voltage (U_{C}) at a moisture film over and/or in the reaction area to change the chemical composition in the reaction area of the sensor.

2. Method according to claim 1, where the chemical composition is changed electrochemically.

3. Method according to claim 1, where a characteristic parameter for determining the supplied chemical element or the supplied chemical compound is maintained at a 4esired, particularly a constant base value for determining a given chemical element or a given chemical compound, by selection of the control voltage (U_{C}).

4. Method according to claim 1, where the control voltage (U_{C}) is varied to check the functionality of the sensor, and at least one obtained output value (U_{DS}) is examined with regard to a difference from a reference value.

5. Method according to claim 1, where the control voltage (U_{C}) is adjusted to set the sensitivity of the sensor to determine a desired chemical element or a desired chemical compound.

6. Method according to claim 1, where a pH change is produced by the control voltage in the moisture film by reduction or oxidation of water or other substances in the moisture film.

7. Sensor for determining a chemical element or a chemical compound (CO₂) in a supplied gaseous medium, the sensor comprising:
a reaction area, on and/or in which the element or the compound brings about a chemical reaction that changes a characteristic parameter of the reaction area,
a sensor element that detects the change in the characteristic parameter,
a signal output at which an output signal (U_{DS}) corresponding to the chemical reaction detected by the sensor element can be detected as the measured variable, and
a reaction control device with an electrode system for applying a control voltage to affect a reaction in the reaction area, and
a surface topology/chemistry is provided of such dimensions/design that during operation a continuous moisture film of deposited moisture coats the surface area between at least two electrodes of the electrode system and the reaction area, and/or passes through the reaction area in this region.

8. Sensor according to claim 7, where the characteristic parameter is the work function.

9. Sensor according to claim 7, where it is an SGFET system.

10. Sensor according to claim 7, where the reaction control device is designed as a stabilizing device for electrochemically changing the characteristic parameter in the sensor layer.

11. Sensor according to claim 10, where the stabilizing device is designed to stabilize the characteristic parameter, particularly a pH value, by compensating for interfering influences.

12. Sensor according to claim 7, where the reaction control device is designed to check sensor function, as a test device for actively changing the characteristic parameter and measuring the change in the output signal (U_{DS}).

13. Sensor according to claim 7, where the reaction control device is designed as a test device for comparing at least one measured output signal (U_{DS}) with at least one reference value.

14. Sensor according to claim 7, where the reaction control device is designed as a sensitivity-adjusting device to actively change the characteristic parameter for determining a desired chemical element or a given chemical compound from a plurality of different determinable elements or compounds.

15. Sensor according to claim 14, where the reaction control device for adjusting the sensitivity has a reference table with reference values for the control voltage (U_{C}).

16. Sensor according to claim 7, in which the reaction control device is designed to change the ratios of hydrogen ions (H⁺) or of an OH group (OH⁻) in and/or on the sensor layer.

17. Sensor according to claim 7, with an electrode system for applying a control voltage (U_{C}) in the reaction area, with the electrode system being adjacent to an electrode for detecting an output signal or a measured value for a change in the characteristic parameter.

18. Sensor according to claim 7, in which the sensor element is designed as an ion-selective field effect transistor or as a CCFET.

19. Sensor according to claim 18, in which the sensor element is formed by the gate of the field effect transistor.

20. Sensor according to claim 7, in which the reaction area is located as a sensor layer between the moisture film and the sensor element.

21. Sensor according to claim 7, in which there is a passage for the gaseous medium between the reaction area and the sensor element.

22. Sensor according to claim 7, in which the surface topology in the region of the continuous moisture film extends over a height range (Δh) in the nanometer range, in particular in the range of 0.1 to 100 nanometers.

23. Sensor according to claim 7, in which the surface topology in the region of the continuous moisture film extends over an edge or step height (Δh) that is smaller than the thickness of the moisture film, in particular in the range of a few nanometers.

24. Sensor according to claim 7, in which the surface topology in the region of the continuous moisture film has edge-free, rounded height transitions between different surface height peaks, particularly surface rounding with a rounding radius in the range of a few nanometers to a few tens of nanometers.

25. Sensor according to claim 7, comprising hydrophilic films between the electrodes and the reaction area.

26. Sensor according to claim 7, in which the electrode system for applying the control voltage is formed of at least two interdigitally intertwined electrodes.

27. Sensor according to claim 7, in which the reaction area has a sensitive layer coated by a moisture film, in or on which at least one electrode of the electrode system is located, with the sensor element being separated from the moisture film by a passage for the gaseous medium.

28. Sensor according to claim 27, in which a second electrode of the electrode system is separated from the first electrode of the electrode system, and is located within the sensitive layer or outside the sensitive layer and is separated from the moisture film.

29. Sensor according to claim 28, in which there is a buffer layer for preventing accumulation of acid, located between the second electrode separated from the sensitive layer and the sensitive layer.
